(19) United States
(12) Patent Application Publication
(10) Pub. No.: US 2007/0056779 A1
(43) Pub. Date: Mar. 15, 2007

(54) Backpack equipped with a weight-measuring device

(76) Inventors: Shlomo Laniado, Tel-Aviv (IL); Ori Laniado, Tel-Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 11/226,438

(22) Filed: Sep. 15, 2005

(51) Int. Cl. A45F 4/02; G01G 23/00; A45F 3/04

(52) U.S. Cl. 177/245; 224/627; 224/153

(57) ABSTRACT

A backpack is described that comprises a bag having a storage compartment, and a backpack harness configured for securing the bag on a user carrying the backpack. The backpack harness includes a pair of shoulder strap assemblies. Each shoulder strap assembly includes a weight-measuring device anchored to the top of the bag, so that when the backpack is carried by the user, the weight load applied to said each strap assembly can be determined. Each strap assembly can include a fastener configured for detaching the corresponding weight-measuring device. The fastener comprises a cylindrical member connected to a first strap section along the cylinder's wall, a tube-shaped member connected to a second strap section along the tube's wall. The tube has a longitudinal slit along its wall to allow the passage of the first strap therethrough. The first strap section is attached to the second strap section by inserting the cylinder in the tube.

### FIELD OF THE INVENTION

This invention relates to a backpack and, more particularly, to a backpack equipped with a weight-measuring device.

### BACKGROUND OF THE INVENTION

Backpacks and shoulder bags are the most popular and effective ways to carry medium to heavy loads while walking. They were originally developed for military and hiking activities and have, over time, become very stylish and popular for students and children for carrying books and school supplies. However, while they are generally considered a good tool to carry large loads because they distribute weight evenly across some of the body's largest muscles, some children carry far too much weight on their young backs.

Medical authorities have set forth certain guidelines and recommendations to demonstrate that improper use and wearing of backpacks can lead to muscle imbalance that can result in chronic back and neck problems. A distinctly important guideline is that suspending too much weight from the shoulders over an extended period has been shown to be detrimental to the back, causing problems ranging from simple discomfort and fatigue to spinal compression, back pain and misalignment of the spine.

The problem has been aggravated in recent years, as young children have been carrying overweight backpacks. In particular, both the American Academy of Orthopedic surgeons (AAOS) and the Consumer Product Safety Commission (CPSC) warn that increasing numbers of children are suffering injuries to their backs and shoulders from improper utilization of their backpacks. Many experts recommend that a child carry no more than 15% of their body weight in a backpack to avoid increased risk of musculoskeletal injury. Children from grade school through high school are currently carrying far in excess of this amount. Excessive weight of a backpack may cause functional scoliosis or curvature of a healthy spine at any age. It is emphasized that even adults should not carry more than 25 kg in a backpack.

The best way to prevent danger from overloaded backpacks is to directly determine if a particular load, in a particular backpack, is too heavy for a particular child or adult to be carrying. While placing the backpack on traditional scales would be suitable for determining the weight of a backpack, scales are not always available to weigh a backpack to ensure that it is not overloaded.

This problem is addressed at U.S. Pat. Publication No. 2005/0051586 to Siwak et al. describing a weight determining mechanism in the structure of backpack or other piece of luggage, particularly in the carry handle, to allow a user to determine the weight of the backpack or other luggage without the need for using an external weighing device.

In addition to the dangers caused by excessive backpack weight, health care professionals advise that the total load should be equally divided between the two shoulder straps to avoid orthopedic injuries associated with shifting of excessive weight to a particular right or left shoulder. It is difficult to conclude about the optimal configuration of a backpack and a harness if the carrier is unaware of the importance of weight distribution between the two shoulders. Asymmetric weight distribution induces the carrier to avoid standing in a proper upright position and thus can lead to spinal injuries, muscle strain or similar problems. In addition, overloading the wearer's shoulders can also cause local injuries, such as strain of the trapezias muscle, pinching of nerve roots near the spine, etc.

Maintaining a natural posture, a person experiences a significant difference between side-to-side, and front-to-back upright stability. It is essential that a natural posture be preserved as closely as possible when carrying a backpack. For side-to-side stability the bag should be symmetrical and evenly loaded on each side. Symmetric loading is of particular importance, since, when most of the pack's weight is carried by slinging it on a single shoulder, it results in encouraging the wearer to bend sideways. Such abnormal posture is even more exaggerated when carrying a heavy backpack. To preserve the body side-to-side stability one has to consider first that there is no significant extra weight applied to one shoulder compared with the other. Imbalanced load hurts the shoulders while compressing on the shoulder and in time may also lead to circulatory or nerve disturbances.

There are numerous known systems for backpacks which attempt to stabilize the load, increase comfort and enhance convenience to the carrier. For example, U.S. Pat. No. 4,217,998 to Alexander describes a weight-balancing device that includes a set of two elongated tubes, disposed in telescopic relation to each other with a spring-loaded push button carried by the inner tube, locking the tubes together so that they can have various desired combined length. One of the tubes has a slip resistant backpack shoulder strap connector attached at its front end and the other tube has a backpack rear frame connector pivotally secured to its rear end.

U.S. Pat. Publication No. 2004/0065708 to Amram describes a backpack that is designed to reduce muscle strain when the bag is carried, by improving the balance of the load. The backpack has straps which may be repositioned, removed and replaced. Repositioning the straps can enable a person to reposition the load closer to the center of the body to reduce leverage exerted by an unbalanced load.

International Pat. Publication No. WO 2004/100706 to Manoni describes a balanced backpack allowing an appropriate weight distribution. The backpack includes a rear bag container associable to a bust by means of a pair of shoulder straps, a fastening point associated to the shoulder straps, and a front bag container fastenable to the fastening point, so as to charge the associated load thereon.

### SUMMARY OF THE INVENTION

There is a need in the art for further improvement of backpacks by providing a novel structure of a backpack equipped with a weight-measuring device that will enable a user to quickly and easily provide a balance control by determining the weight load carried by each shoulder along with the total weight carried by the user.

It should be noted that the term “backpack” within the present invention has a general meaning. For the purpose of the present description and interpretation of the claims, the terms “backpack”, “book bag”, “knapsack”, “rucksack”, “haversack”, “duffle bag”, etc. are deemed synonymous.

The present invention partially eliminates disadvantages of the conventional backpacks and provides a novel backpack equipped with weight-measuring devices for control of backpack balance. A particular advantage of this invention is parents' awareness of any deterioration incurred when a child uses a backpack, related to excessive load, asymmetric strap configuration and/or inter-shoulder weight imbalance.

The objective of the invention is achieved through providing a pair of weight-measuring devices incorporated into integral or removable sections of the shoulder strap assemblies. The weight-measuring devices can display the weight load carried by the particular shoulder. When required, the total weight carried by the user can be easily estimated. The combined load sensed by both weight-measuring devices is the total weight of the backpack carried by the user while the right and left weight-measuring devices separately register the load carried by the corresponding shoulder. Moreover, the weight-measuring devices can include an alarm system for warning if total weight of the backpack exceeds the allowed weight.

The weight-measuring devices can be of a mechanical or electronic nature. According to one embodiment of the invention, the weight-measuring device is based on an expandable elastic strap constructed in line with the shoulder strap, and situated between both proximal and distal sections of the shoulder strap assembly. According to another embodiment of the invention, the weight-measuring device is based on expandable spring that can be stretched in relation to the force applied to its edges. According to yet another embodiment of the invention, the weight load measurements are carried out by an electronic strain-gauge sensor, which reports the force applied thereto by using electrical signals and a digital numerical output.

Asymmetric load between the two shoulders is readily discerned. In the event that the measuring device indicates shoulder load imbalance (which could be a consequence of asymmetric shoulder straps position or right to left asymmetry in the placement of the heavy objects within the bag), the imbalance can be corrected. The correction can be made by readjusting the straps in the harness and/or by rearranging the bag's contents (i.e. shifting heavy objects from side to side).

To avoid having unbalanced contents within the bag, or to avoid an exaggerated total load, partitions can be introduced inside the bag, to be secured for example by VELCOR™ strips to one (or two) walls of the bag. Such lightweight partitions, or separators, can be made of foamed polystyrene (e.g., STYROFOAM™) blocks covered by compressible and pliant rubber foam material. Likewise, the backpack can be equipped with detachable plates or blocks of extremely light material (e.g., polystyrene) covered by rubber foam) which, by being shifted from one side of the bag to the other, can determine the volume distribution of loads within a storage compartment of the backpack. Such space occupying plates (being of negligible weight), when attached to the side walls of the backpack compartment, reduce the remaining space available for heavy loads (e.g., books). This can prevent, for example, a child from overly loading the bag with heavy goods, unaware that the backpack's weight load is asymmetrical (i.e. the load affecting one shoulder, as appreciated by the measuring device, is significantly larger than that loading the other). Likewise, stirring the foam plates attached to the particular side of the bag can shift the heavier contents of the bag to achieve balanced state.

Thus, according to one general aspect of the present invention, there is provided a backpack comprising a bag having a storage compartment, and a backpack harness configured for securing the bag on a user carrying the backpack, wherein said backpack harness includes a pair of shoulder strap assemblies, each shoulder strap assembly including a weight-measuring device anchored to the top of the bag, so that when the backpack is carried by the user, the weight load applied to said each strap assembly can be determined.

According to an embodiment of the invention, each weight-measuring device is an integrated part of the corresponding shoulder strap assembly.

According to another embodiment of the invention, each strap assembly includes two fasteners configured for detaching the corresponding weight-measuring device. Preferably, the fastener is configured as a Rotation Adjusted Fastener according to the invention.

According to another aspect of the invention, there is provided a novel Rotation Adjusted Fastener that provides quick and secure attachment between two apposing strap (or belt) sections with the option of markedly quick release. It should be noted that these two strap sections (or belt sections) can be either two different sections of the same strap (or belt) or two sections of two different straps (or belts).

Accordingly, there is provided a fastener for joining a first strap section and a second strap section, the fastener comprising: a cylindrical member connected to said first strap section along the cylinder's wall, a tube-shaped member connected to said second strap section along the tube's wall and having an inner diameter larger than the diameter of the cylinder such that the cylinder is insertable into a lumen of the tube and rotatable thereinside, the tube having a longitudinal slit along its wall to allow the passage of the first strap therethrough, whereby the first strap section is attached to the second strap section by inserting the cylinder in the tube.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a front perspective view of an embodiment of the backpack constructed in accordance with the present invention;

FIGS. 2A and 2B show an example of the weight-measuring device employed with the backpack of the present in the unloaded and loaded states, correspondingly;

FIG. 3 shows a front perspective view of another embodiment of the backpack constructed in accordance with the present invention;

FIGS. 4A and 4B show another example of the weight-measuring device employed with the backpack of the present invention in the unloaded and loaded states, correspondingly;

FIG. 5 shows a rear perspective view of still another embodiment of the backpack constructed in accordance with the present invention;

FIG. 6 shows still another example of the weight-measuring device employed with the backpack of the present invention;

FIGS. 7A and 7B illustrate prospective views of an exemplary Rotation Adjusted Fastener of the present invention in the unfastened and fastened states, respectively.

FIG. 8 illustrates a cross-sectional view of the fastener across the plane A-A′ in FIG. 7B is shown according to an embodiment of the invention;

FIG. 9 illustrates the utilization of the Rotation Adjusted Fastener of the present invention for fastening a belt for trousers;

FIG. 10 illustrates an example of utilization of the Rotation Adjusted Fastener of the present invention for fastening straps of a shoe;

FIG. 11 illustrates a prospective view of a portion of an exemplary fence of the present invention;

FIG. 12 illustrates a cross-sectional view of the post of the fence shown in FIG. 11, according to an embodiment of the invention; and

FIG. 13 illustrates an example of application of the fence of the present invention for building a wall of a pool.

### DETAILED DESCRIPTION OF EXEMPLARY EMBODIMENTS

The principles and operation of a backpack according to the present invention may be better understood with reference to the accompanying description and the drawings, in which preferred embodiments of the invention are illustrated. It should be understood that these drawings are given for illustrative purposes only and are not meant to be limiting. The present invention may be embodied in many different forms and should not be construed as limited to the embodiments set forth herein. The same reference numerals and alphabetic characters will be utilized for identifying those components which are common in the backpack and its components shown in the drawings throughout the present description of the invention.

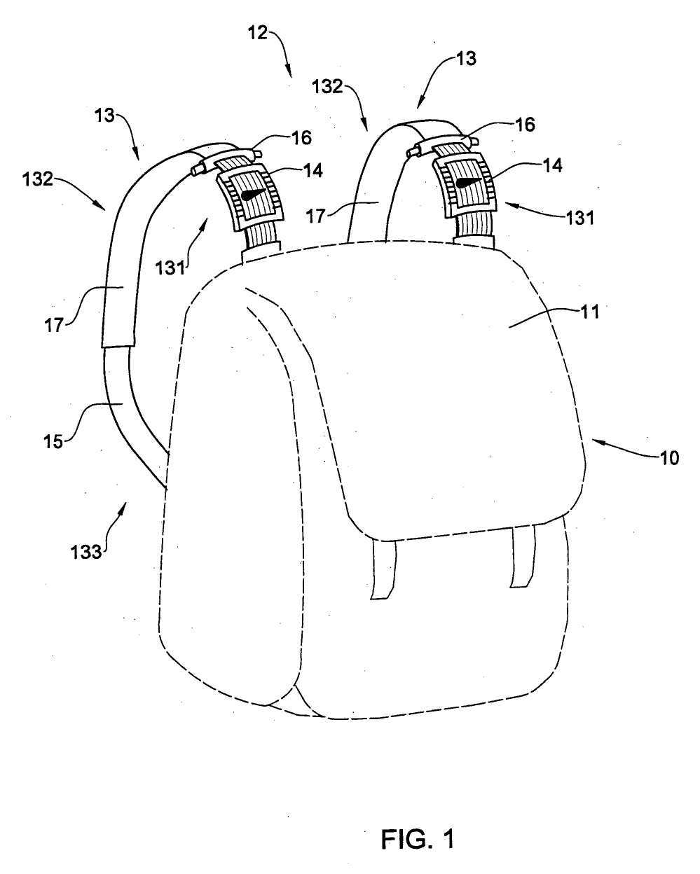

Referring to FIG. 1, a front perspective view of an embodiment of a backpack 10 constructed in accordance with the present invention is illustrated. The backpack 10 includes a bag 11 having a storage compartment, and a backpack harness 12 configured for securing the bag 11 on a user (not shown) carrying the backpack 10. The bag 11 can be made of any sufficiently strong flexible material, e.g., nylon, canvas, GORTEX™, etc.

The backpack harness 12 includes a pair of strap assemblies 13 having a shoulder portion 131, a chest portion 132 and a waist portion 133. In the shoulder portion 131, each strap assembly 13 includes a weight-measuring device 14 anchored to the top of the bag 11, so that when the backpack 10 is carried by the user, the weight load applied to the each of the strap assemblies 13 can be readily determined or estimated by the user.

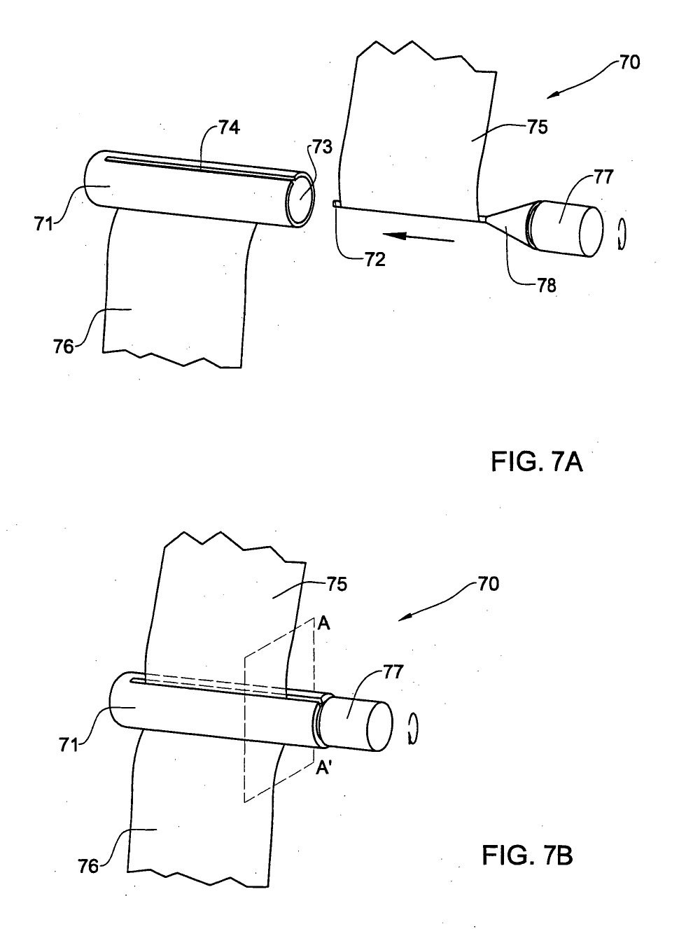

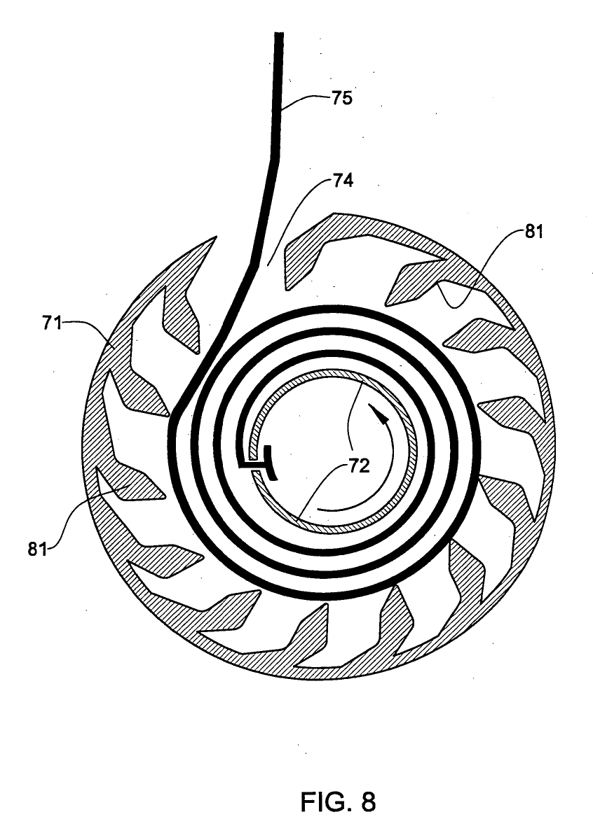

Each strap assembly 13 also includes a shoulder strap 15 coupled to the weight-measuring device 14 and to the bottom of the bag 11. The shoulder strap and the weight-measuring device 14 can be coupled together by a length adjustment fastener 16. The fastener 16 is operable to adjust the length of the shoulder strap 15 to provide a comfortable fit for users of various sizes. The fastener 16 may have any suitable configuration. Preferably, it is configured as a Rotation Adjusted Fastener of the present invention, as will be described further below with reference to FIGS. 7A-7B and 8.

The shoulder straps 15 can be made of any sufficiently strong and flexible material, e.g., leather, nylon, canvas, etc. Preferably, the shoulder straps 15 should have a width of at least 2 inches (about 7 cm), to avoid high pressure on the user's shoulders and chest.

According to one example, the shoulder strap 15 is one piece continuous strap. When desired, the shoulder strap 15 can include a pad 17 located at least partially in the shoulder and chest portions 131 and 132, to decrease pressure on the user's shoulders and chest for the user's comfort. According to another example, shoulder strap 15 is fabricated from two (or more) sections connected to each other to form a continuous strap. One of the sections can be the pad 17 and the other section can be an adjustment strap (not shown in FIG. 1). The adjustment strap can be connected to the pad 17 by means of another length adjustment fastener (not shown in FIG. 1) and to the bottom of the bag 11 by stitching.

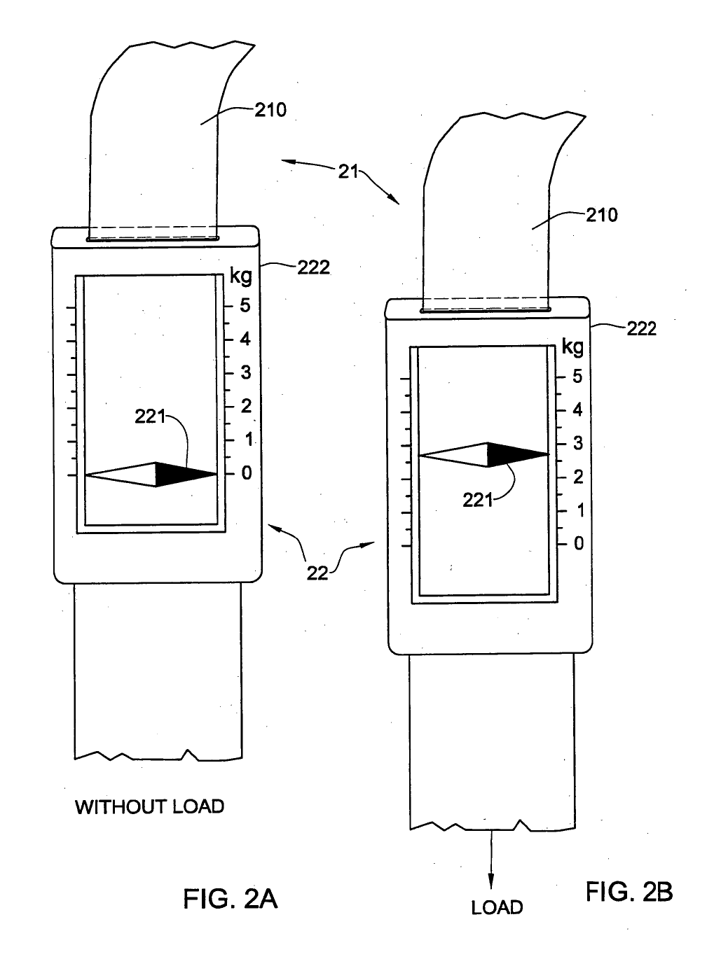

Referring to FIGS. 2A and 2B, an example of the weight-measuring device 14 is illustrated in the free (unloaded) and loaded states, correspondingly. The weight-measuring device 14 includes a force resistance element 21 and a weight indicator 22. The force resistance element 21 can be altered by the application of force thereto. In turn, the weight indicator 22 can provide an indication of the force magnitude.

According to the example shown in FIGS. 2A and 2B, the force resistance element 21 includes an elastic band 210 connected to the top of the bag (not shown in FIG. 2) and to the shoulder strap (15 in FIG. 1). The elastic band 210 can be stretched in proportion to the dynamic load applied to the strap. An example of the material suitable for the elastic band 210 includes, but is not limited to, rubber.

The weight indicator 22 includes a pointer 221 associated with the elastic band 210 and a calibrated scale 222 arranged near the pointer 221. For example, the pointer 221 can be painted on the elastic band 210. The stretching of the elastic band 210 displaces the pointer 221 along the calibrated scale 222, to provide numerical indications (e.g., in pounds and/or kilograms) of the weight loaded on the particular shoulder strap, thus depicting the load carried by the corresponding shoulder.

When required, the weight scale accurate calibration can be checked and corrected. This may be suggested following long use, when the stretchable element may become slightly lax and overly extended to show false reading. A proper calibration can, for example, be performed while comparing indications of the weight indicator 22 against a know amount of weight (e.g., a pack of sugar of 10 Lbs, or a weight-dumbbell) hanging on the strap. Then, the pointer 221 can be fixed to fit the actual weight corresponding to new display. Thus, the weight-measuring device 14 will resume accuracy.

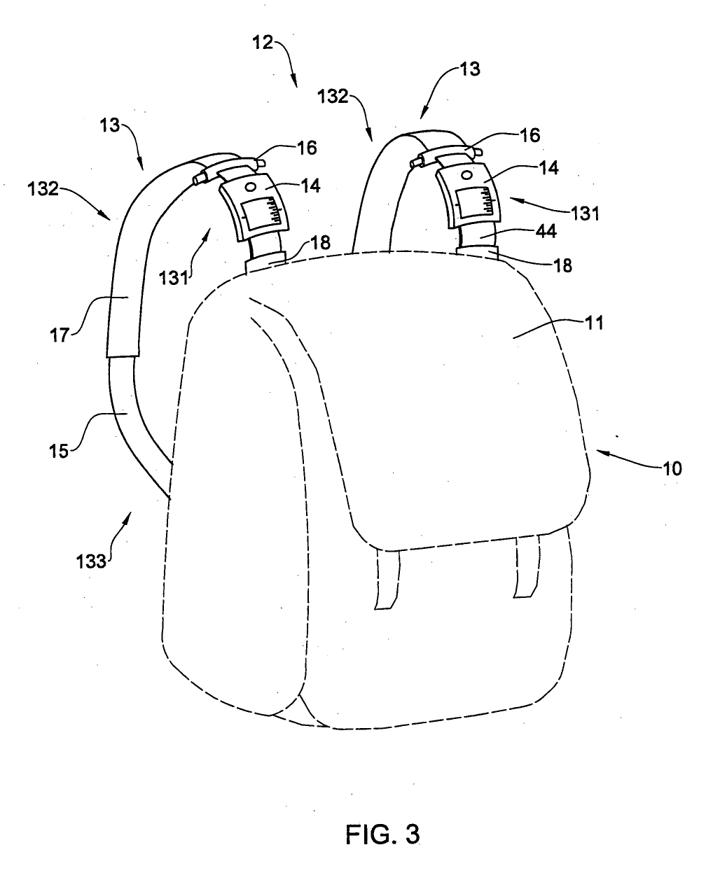

Referring to FIG. 3, a front perspective view of another embodiment of the backpack 10 constructed in accordance with the present invention is illustrated. The backpack of this embodiment differs from the backpack shown in FIG. 1 in the employment of the different weight-measuring devices 14 mounted with the strap assemblies 13.

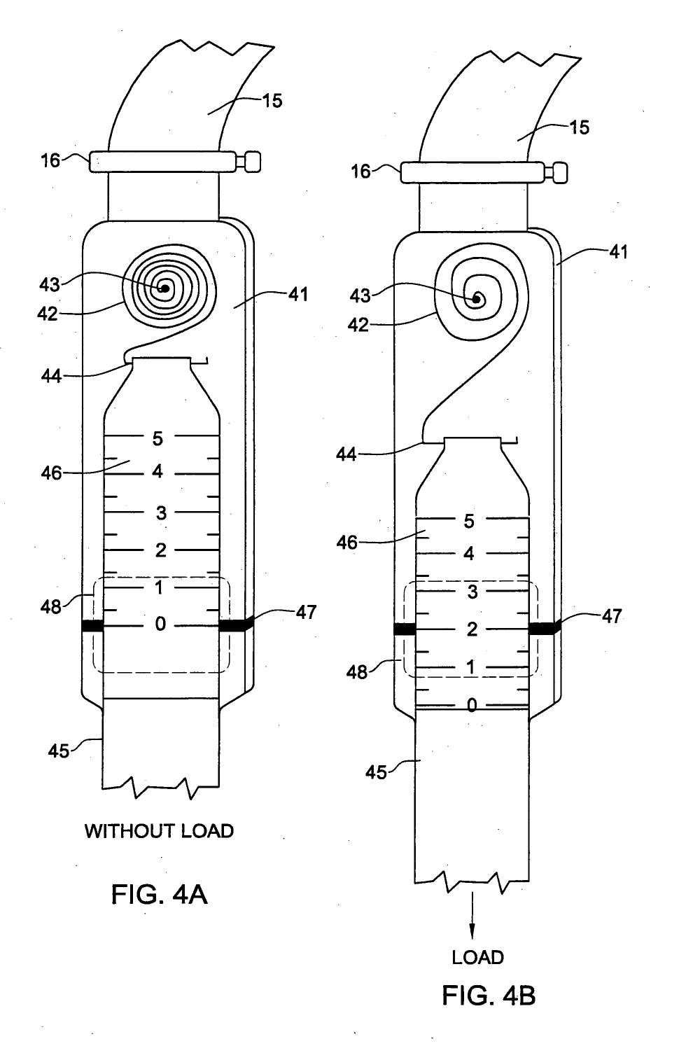

Referring to FIGS. 3, 4A and 4B together, the weight-measuring device 14 includes a case 41 coupled to the shoulder strap (15 in FIG. 3), and an expandable spring 42 located within the hollow interior of the case 41. Preferably, but not mandatory, the case 41 is coupled to the shoulder strap 15 through the length adjustment fastener 16.

The case 41 is shown without an upper cover, for purposes of clarity. An example of the expandable spring 42 includes, but is not limited to, a coil spring. In this case, a central edge 43 of the coil spring 42 is fixed to the case, so that the coil spring 42 can be stretched in relation to the force applied to its free edge 44. The free edge 44 is anchored, through a top strap 45, to the top (e.g., to the upper margin) of the backpack 10, thus the expandable spring 42 can be stretched in proportion to the weight loaded to the corresponding shoulder. The top strap 45 includes a scale 46 that moves against a pointer 47 marked on the case 41. A weight indication can be seen in a window 48 provided within the upper cover of the case 41.

It should be appreciated by a person versed in the art that the weight scale accurate calibration of the weight measuring device 14 can be checked and corrected, when required, by comparing indications of the pointer 47 with respect to a known amount of weight applied to the corresponding strap shoulder.

It should be noted that the weight measuring device 14 as described above is an integral part of the strap assemblies 13. On the other hand, since the weight-measuring device 14 utilized in the embodiment shown in FIG. 3 contains an expandable spring 42 which is, preferably, made of metal, it might be recommended to temporarily detach the weight-measuring device 14 from the backpack 10 when washing the bag. Accordingly, when desired, the strap assemblies 13 can include a top fastener (i.e., a buckle) 18 for connecting the top strap 45 to the upper margin of the backpack 10.

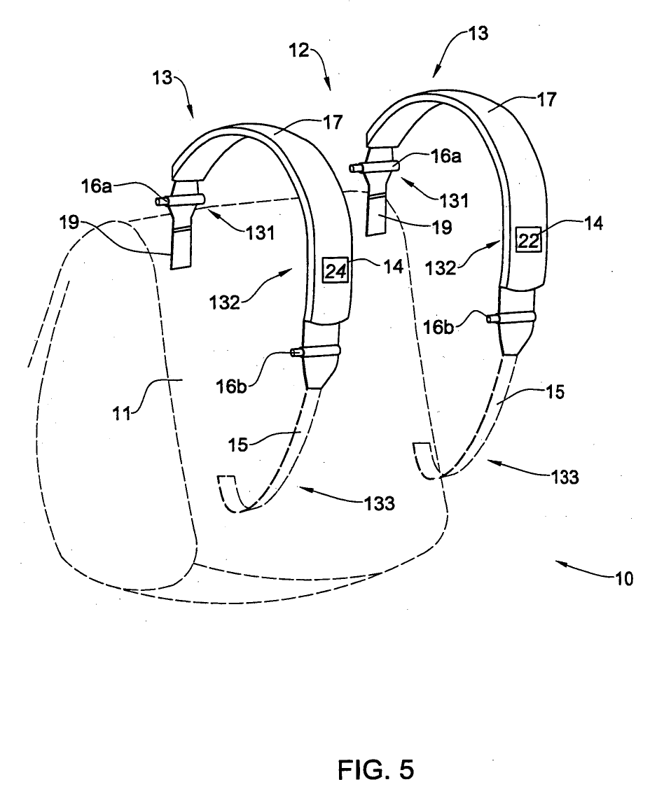

Referring to FIG. 5, a rear perspective view of still another embodiment of the backpack 10 constructed in accordance with the present invention is illustrated. The backpack of this embodiment differs from the backpack shown in FIGS. 1 and 3 in the employment of the different weight-measuring devices 14 mounted with the strap assemblies 13.

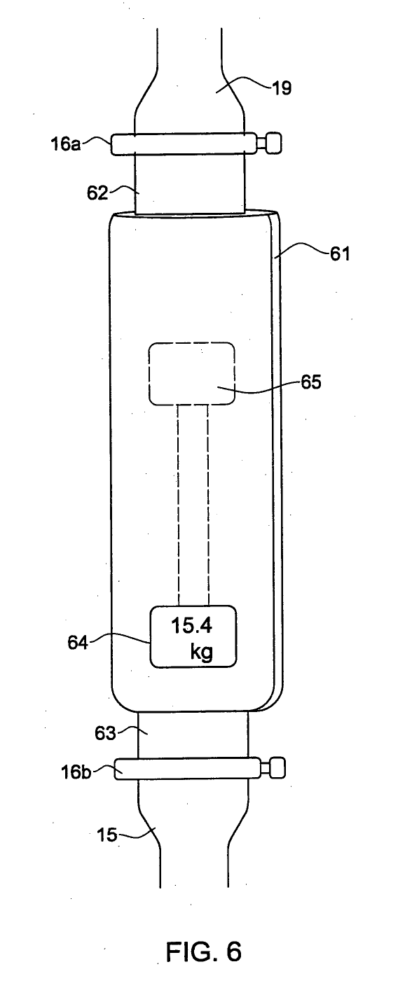

FIG. 6 illustrates the weight-measuring device 14 utilized in the embodiment shown in FIG. 5. According to this embodiment, the weight-measuring device 14 includes an electronic strain-gauge sensor (load cell) 61, which reports the force applied to edges 62 and 63 by using electrical signals and a digital numerical output. The electronic strain-gauge sensor 61 can report the actual load applied to the corresponding shoulder strap on a display indicator 64 and be powered by a power source 65. Examples of the electrical power source 65 include, but are not limited to, a rechargeable battery, solar battery, etc. The electronic strain-gauge sensor is known per se. Therefore, the electronic scheme of this device will not be expounded hereinbelow. The total weight carried by the user can be easily estimated. The combined load sensed by the both weight-measuring devices is the total weight of the backpack carried by the user while the right and left weight-measuring devices separately register the load carried by the corresponding shoulder. Thus, when required, the weight-measuring device 14 can include a microprocessor (not shown), coupled to the electronic strain-gauge sensors of each strap assembly, that is configured to calculate and provide a total weight load carried by the left and right shoulders. Moreover, the weight-measuring devices can include an alarm system (not shown) for warning if the load on the shoulders is not balanced well, and/or if the total weight load carried by of the backpack exceeds the allowed.

Turning back to FIG. 5, as noted above, when required, the weight-measuring device can be detached from the main backpack, e.g., when the backpack is put in the laundry. In such a case, the weight-measuring device 14 can be mounted with the strap assemblies 13 with the help of two fasteners 16a and 16b, which can also operate for adjusting the length of an upper strap 19 anchored to the backpack and the shoulder strap 15, respectively.

It should be understood that the weight-measuring device 14 can be mounted within special foaming pads 17 insulating the user from relatively rugged margins of the electronic sensors, thus protecting the carrier's shoulders from unnecessary irritation and/or pressure.

According to another aspect of the invention, there is provided a novel Rotation Adjusted Fastener that provides quick and secure attachment between two apposing strap (or belt) sections with the option of markedly quick release. It should be noted that these two strap sections (or belt sections) can be two different sections of the same strap (or belt). Likewise, these two strap sections (or belt sections) can be two sections of two different straps (or belts).

In particular, such a Rotation Adjusted Fastener can be used as the length adjustment fasteners (16 in FIGS. 1 and 3) and (16a and 16b in FIGS. 5 and 6).

Referring to FIGS. 7A and 7B, prospective views of an exemplary Rotation Adjusted Fastener 70 are illustrated in the unfastened and fastened states, respectively. The Rotation Adjusted Fastener 70 includes a tube (tube-shaped member) 71 and a cylinder 72 having a diameter smaller than the inner diameter of the tube 71, to provide that the cylinder 72 can easily slide into the lumen 73 of the tube 71. Thus, the cylinder 72 defines a “male” part of the fastener 70, whereas the tube 71 defines a “female” part of the fastener 70, correspondingly. The cylinder 72, along its cylinder wall, is connected to a section (e.g., an edge) of a first strap (or belt) 75. The tube 71 has a longitudinal slit 74 along its wall to allow the passage of the first strap 75 therethrough when inserting the cylinder 72 into the tube 71. The tube 71, along its wall, is connected to a second strap (or belt) 76. Preferably, the place of this connection is selected on the region of the wall which is diametrically opposite to the slit 74. In the fastened state (when the cylinder 72 is inserted in the tube 71), the section of the first strap 75 connected to the cylinder 72 will be attached to the edge of the second strap 76 connected to the tube 71.

The cylinder 72 on one of its ends is equipped with a knob (or button) 77 that allows manual rotation of the cylinder 72. Such rotation winds the first strap 75 around a longitudinal axis O of the cylinder 72, thereby reducing the redundant extra length of the strap as it is wrapped around the cylinder, and, when this is done while the cylinder 72 is inside the tube 71, increasing the ongoing tension between the two strap members to be connected.

In the unfastened state, the male and female parts of the fastener are separated. Upon fastening, the male part slides into the female part, such that the first strap 75 slides through the slit 74. In order to avoid release of the male from the female part under pull, the knob 77 has a tapered part 78. By a gentle push on the knob 77 inward, the tapered part 78 entering the tube 71 will provide connection between the inner surface of the tube and the tapered part 78, thereby enforcing the friction therebetween, to avoid incidental separation of the male and female parts, i.e., locking the fastener 70.

The fastener 70 allows the selection of any degree of tension or laxity involving the connection between the two opposing straps or belts to be brought together. Tightening the fasten straps 75 and 76 can be achieved by slightly pulling out the knob 77 in order to release it from the lock position. Then, by rotating the knob, the first strap 75 will rewind around the male part to increase tension. After tightening, the knob 77 can be pushed inward to return the fastener 70 to the locked state.

The Rotation Adjusted Fastener 70 has the advantages of a safe fastening and quick release assembly which has ability to sustain high tension while securing belts together in fixed yet desired position. It is simple to operate. In other words, it is easy to fasten and release, and to keep it secure, under pressure. The tension which is applied on the joined strap or belt, is selected by the user.

Referring to FIG. 8 a cross-sectional view of the Rotation Adjusted Fastener 70 across the plane A-A′ in FIG. 7B is exemplified. According to this embodiment, at least a portion of the strap 75 that enters the tube 71 (e.g., at least the surface of the strap facing the inner surface of the tube 71) should have a special high friction texture, and the inner surface of the tube 71 includes pliable teeth 81. The teeth 81 are configured to allow the rotation of the cylinder 72 in one direction only (shown by the arrow 82). This provision can help the user to tighten the fasten straps 75 and 76 (not shown in FIG. 8). In turn, the first strap 75 that is attached to the male part of the fastener can be of different fabrics such as: woven fabric, polyester, non-woven, synthetic leather, nylon and the similar materials. When required, the straps 75 and 76 can be elastic.

It should be appreciated that the Rotation Adjusted Fastener of the present invention is an ideal means for use in any appliance or item of clothing where various buckles may be used. Such appliances, and garments and particularly those characterized by connecting belts or leather straps, or various types of straps or belts such as those used for trousers, shoes, luggage accessories, wrist watches, shirts, sweaters, suspenders, etc.

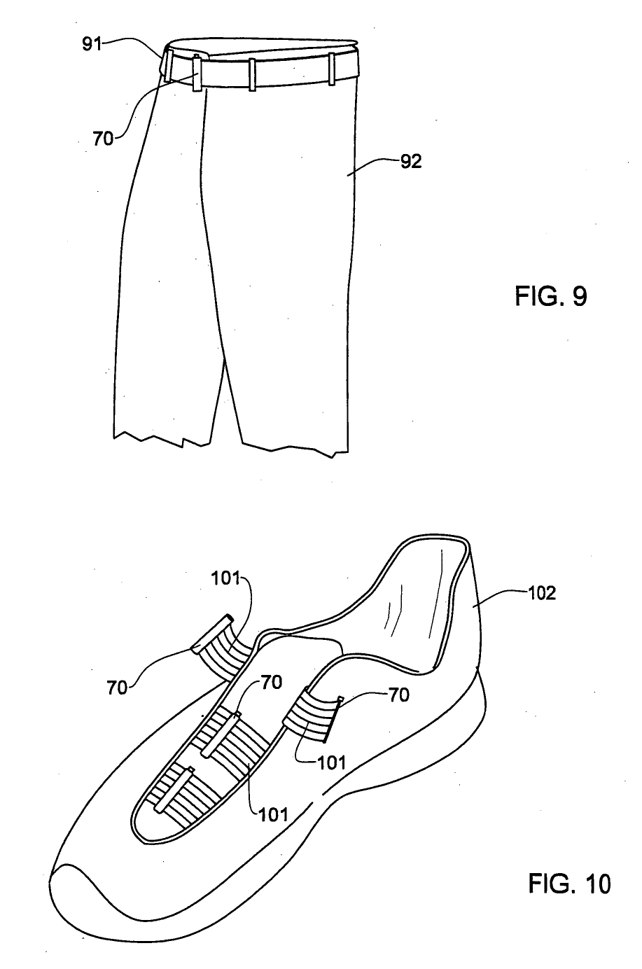

For example, FIG. 9 illustrates the utilization of the Rotation Adjusted Fastener 70 for fastening a belt 91 for trousers 92. FIG. 10 illustrates an example of utilization of the Rotation Adjusted Fastener 70 for fastening straps 101 of a shoe 102.

It should be appreciated that the Rotation Adjusted Fastener of the present invention has a particular advantage when it is used to control tension between two strap sides to be connected. Examples of utilization of the fastener include, but are not limited to, watches, shoes, trouser belts, sport shoes, etc.

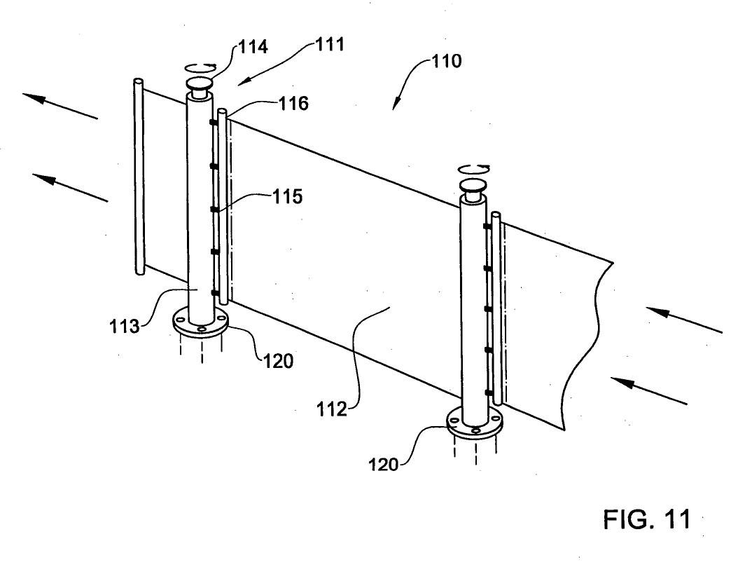

It should be appreciated that the principle of the Rotation Adjusted Fastener of the present invention can be used for creating a fence or enclosure. With reference to FIG. 11, a perspective view of a portion of an exemplary fence 110 of the present invention is illustrated. The fence 110 includes a plurality of posts 111 connected to each other in series by rectangular sheets (straps) 112 composed of a flexible material. The construction of the post 111 is based on the principle of the Rotation Adjusted Fastener of the present invention described above. Specifically, each post 111 includes a tube 113 and a cylinder 114. The cylinder 114 has a diameter smaller than the inner diameter of the tube 113, to provide that the cylinder 114 can easily slide into the tube 113. When required, the tube can be attached to a base 120 configured for mounting the fence 110 in the vertical or another desired position.

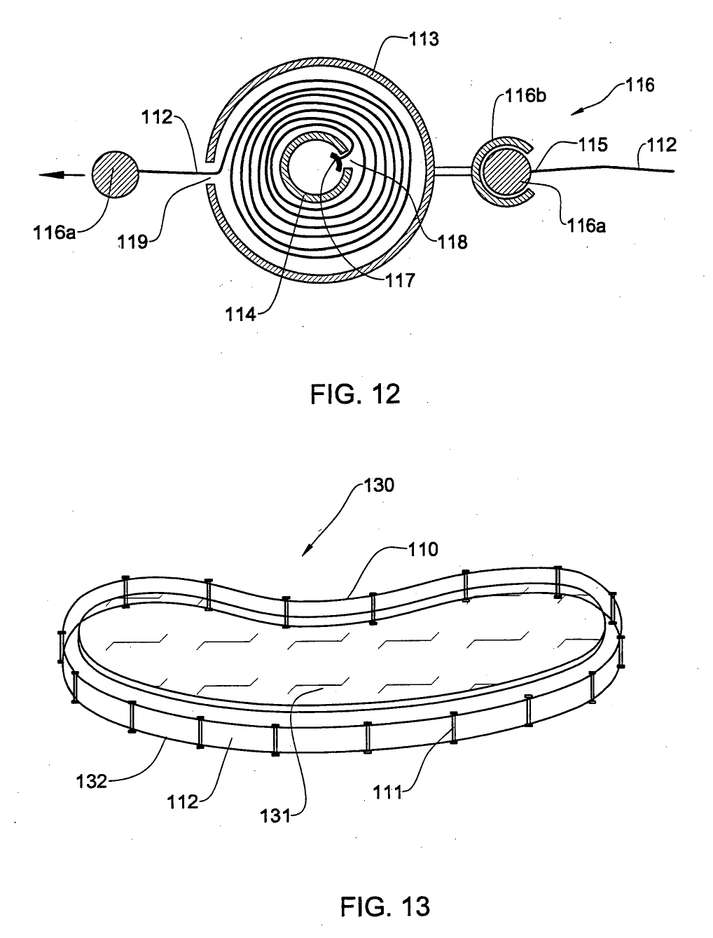

FIG. 12 shows a cross-sectional view of the post 111, according to an embodiment of the invention. An edge 115 of the rectangular sheet 112 is coupled to the cylinder 111 along the cylinder's wall through a buckle 116. The buckle 116 has a male part 116a and a female part 116b. For example, the male part 116a has a shape of a cylinder and connected to the edge 115 along the cylinder's wall. In turn, the female part 116b can be in the trough-shaped form capable of holding the male part 116a. According to this embodiment, the female part 116b is directly connected to the tube 113. The tube 113 has a longitudinal slit 119 along its wall to allow the passage of the rectangular sheet 112 therethrough. Preferably, the female part 116b of the buckle 116 is connected to the tube 113 at the place which is diametrically opposite to the slit 119. Another edge 117 of the rectangular sheet 112 is anchored to the cylinder 114. The cylinder 114 can be in tubular form. In such a case, a slit 118 can be formed along the cylinder 114 to hold the edge 117 therein.

The operation of the posts 111 is similar to the operation of the Rotation Adjusted Fastener (70 in FIGS. 7A, 7B and 8). For instance, in order to adapt the length of the fence, the rectangular sheet 112 between any two posts 111 can be rewound around the corresponding cylinder 114.

Referring to FIG. 13, an example of application of the fence of the present invention for building a wall of a pool 130 is illustrated. The pool 130 includes the fence part 110 and a bottom part 131 which are hermetically sealed along the circumference of the bottom part. This configuration allows for readjusting the pool size.

As such, those skilled in the art to which the present invention pertains, can appreciate that while the present invention has been described in terms of preferred embodiments, the conception, upon which this disclosure is based, may readily be utilized as a basis for the design of other structures systems and processes for carrying out the several purposes of the present invention.

It is to be understood that the phraseology and terminology employed herein are for the purpose of description and should not be regarded as limiting.

It is important, therefore, that the scope of the invention is not construed as being limited by the illustrative embodiments set forth herein. Other variations are possible within the scope of the present invention as defined in the appended claims.

1. A backpack comprising a bag having a storage compartment, and a backpack harness configured for securing the bag on a user carrying the backpack, wherein said backpack harness includes a pair of shoulder strap assemblies, each shoulder strap assembly including a weight-measuring device anchored to the top of the bag, so that when the backpack is carried by the user, the weight load applied to said each strap assembly can be determined.

2. The backpack of claim 1, wherein said weight-measuring device includes a force resistance element altered by the application of force thereto and a weight indicator providing an indication of the force magnitude.

3. The backpack of claim 2, wherein said force resistance element includes an elastic band connected to the top of the bag.

4. The backpack of claim 3, wherein said weight indicator includes a pointer associated with said elastic band and a calibrated scale arranged near the pointer, where the pointer is displaced along the calibrated scale when the elastic band is stretched by the weight load applied thereto, thereby providing numerical indications of the weight.

5. The backpack of claim 2, wherein said force resistance element includes an expandable spring.

6. The backpack of claim 1, wherein said weight-measuring device includes a case, and an expandable spring located within the hollow interior of the case and having a first edge and a second edge, said first edge being fixed to the case, said second edge being anchored to the top of the backpack, where the expandable spring is stretched in proportion to the weight loaded applied thereto.

7. The backpack of claim 6, wherein said second edge is anchored to the top of the backpack through a top strap having a calibrated scale that moves against a pointer marked on the case, thereby providing numerical indications of the weight.

8. The backpack of claim 1, wherein said weight-measuring device includes an electronic strain-gauge sensor.

9. The backpack of claim 1, wherein each strap assembly includes a shoulder strap coupled to the weight-measuring device and to a bottom of the bag.

10. The backpack of claim 9, wherein the shoulder strap and the weight-measuring device are coupled together by a length adjustment fastener operable to adjust the length of the shoulder strap, thereby to provide a comfortable fit for the user.

11. The backpack of claim 1 wherein said weight-measuring device is an integral part of the corresponding strap assembly.

12. The backpack of claim 1 wherein the each of the shoulder strap assemblies includes two fasteners configured for detaching the corresponding weight-measuring device.

13. The backpack of claim 10, wherein said length adjustment fastener comprises a cylindrical member connected to said a first strap section along the cylinder's wall, a tube-shaped member connected to said second strap section along the tube's wall and having an inner diameter larger than the diameter of the cylinder such that the cylinder is insertable into a lumen of the tube and rotatable thereinside, the tube having a longitudinal slit along its wall to allow the passage of the first strap therethrough, whereby the first strap section is attached to the second strap section by inserting the cylinder in the tube.

14. The backpack of claim 13, wherein said length adjustment fastener further includes a knob arranged at one end of the cylinder for providing a manual rotation thereof to wind the first strap around a longitudinal axis of the cylinder, thereby reducing the redundant extra length of the first strap as it is getting wrapped around the cylinder, and increasing the ongoing tension between the joined first and second straps.

15. The backpack of claim 14, wherein at least a portion of the knob is tapered for locking said length adjustment fastener when the cylinder is inserted in the tube.

16. The backpack of claim 13, wherein at least a portion of the first strap has a high friction texture, and the inner surface of the tube is formed with pliable teeth allowing the rotation of the cylinder in one direction only.

17. A fastener for joining a first strap section and a second strap section, the fastener comprising: a cylindrical member connected to said first strap section along the cylinder's wall, a tube-shaped member connected to said second strap section along the tube's wall and having an inner diameter larger than the diameter of the cylinder such that the cylinder is insertable into a lumen of the tube and rotatable thereinside, the tube having a longitudinal slit along its wall to allow the passage of the first strap therethrough, whereby the first strap section is attached to the second strap section by inserting the cylinder in the tube.

18. The fastener of claim 17, further including a knob arranged at one end of the cylinder for providing a manual rotation thereof to wind the first strap around a longitudinal axis of the cylinder, thereby reducing the redundant extra length of the first strap as it is getting wrapped around the cylinder, and increasing the ongoing tension between the joined first and second straps.

19. The fastener of claim 18, wherein at least a portion of the knob is tapered for locking said length adjustment fastener when the cylinder is inserted in the tube.

20. The fastener of claim 17, wherein at least a portion of the first strap has a high friction texture, and the inner surface of the tube includes pliable teeth allowing the rotation of the cylinder in one direction only.

21. A piece of garment comprising the fastener of claim 17.

22. A fence of an adjustable length, the fence comprising an array of spaced-apart posts connected to each other via straps in the form of substantially rectangular sheets, each of said posts being configured as the fastener of claim 17.
